(19) United States
(12) Patent Application Publication
(10) Pub. No.: US 2016/0246896 A1
(43) Pub. Date: Aug. 25, 2016

(54) METHODS AND SYSTEMS FOR IDENTIFYING TARGET USERS OF CONTENT

(71) Applicant: XEROX CORPORATION, Norwalk, CT (US)

(72) Inventors: Akhil Arora, New Delhi (IN); Sainyam Galhotra, Chandigarh (IN); Shourya Roy, Bangalore (IN); Srinivas Virinchi, Bangalore (IN)

(21) Appl. No.: 14/628,070

(22) Filed: Feb. 20, 2015

(51) Int. Cl. G06F 17/30

(52) U.S. Cl. CPC G06F 17/30958; G06F 17/3053

(57) ABSTRACT

The disclosed embodiments illustrate methods and systems for identifying one or more target users, of a first content, from a social network. The disclosed method includes generating a graph comprising one or more nodes, representative of one or more users of the social network, and one or more edges connecting the one or more nodes. Thereafter, a first set of nodes is selected from the one or more nodes based on at least a first score and/or a second score. Finally, a third set of nodes is selected from the first set of nodes based on at least a polarity score associated with a second set of nodes, determined based on at least a first weight and a second weight, connected to each node in the first set of nodes, wherein the third set of nodes represents the one or more target users.

### TECHNICAL FIELD

The presently disclosed embodiments are related, in general, to data mining. More particularly, the presently disclosed embodiments are related to methods and systems for identifying target users of content.

### BACKGROUND

With the advancements and ever-increasing popularity of social media platforms such as FACEBOOK, LINKEDIN, TWITTER™, and the like, individuals or organizations are increasingly extracting and analyzing data corresponding to users of the social media platforms. As the social media platforms may be one of the largest sources of such data, the information of corresponding to the one or more users extracted from the social media platforms may be useful in determining which of the one or more users may be interested in receiving a particular targeted content.

However, as millions of users may be active/have accounts on the social media platforms, identifying relevant users for the targeted content on the social media platforms may be a humongous task. Further, the count of such users identified from the social media platforms may also be very large. Therefore, transmitting content to each of the identified users may be cost ineffective for the organization.

### SUMMARY

According to the embodiments illustrated herein, there is provided a method for identifying one or more target users, of a first content, from a social network. The method includes generating, by a graph processor, a graph comprising one or more nodes and one or more edges connecting the one or more nodes. Each of the one or more nodes in the graph is representative of a user of the social network, and an edge, from the one or more edges in the graph, is representative of an acquaintance between a pair of nodes connected by the edge. Further, the method includes determining, by an arithmetic logic unit in one or more processors, a first score and a second score for each of the one or more nodes based on at least depth parameters associated with the graph. Further, the method includes selecting, by the one or more processors, a first set of nodes from the one or more nodes based on at least one of the first score and the second score. The method further includes determining, by the arithmetic logic unit in the one or more processors, a polarity score for each node in the first set of nodes based on one or more actions performed by users, represented by the first set of nodes, on a second content, wherein the second content is similar to the first content. The method further includes determining, by the arithmetic logic unit in the one or more processors, the polarity score for each node in a second set of nodes connected to each node from the first set of nodes based on a first weight and a second weight, associated with edges connecting the second set of nodes, and the polarity score associated with each node in the first set of nodes. Thereafter, the method includes selecting, by the one or more processors, a third set of nodes from the first set of nodes based on at least the polarity score associated with the second set of nodes connected to each node in the first set of nodes, wherein the third set of nodes represents the one or more target users.

According to the embodiments illustrated herein, there is provided a system for identifying one or more target users, of a first content, from a social network. The system includes a graph processor configured to generate a graph comprising one or more nodes and one or more edges connecting the one or more nodes. Each of the one or more nodes in the graph is representative of a user of the social network, and an edge, from the one or more edges in the graph, is representative of an acquaintance between a pair of nodes connected by the edge. The system further includes one or more processors configured to determine a first score and a second score for each of the one or more nodes based on at least depth parameters associated with the graph. The one or more processors are further configured to select a first set of nodes from the one or more nodes based on at least one of the first score and the second score. The one or more processors are further configured to determine a polarity score for each node in the first set of nodes based on one or more actions performed by users, represented by the first set of nodes, on a second content, wherein the second content is similar to the first content. The one or more processors are further configured to determine the polarity score for each node in a second set of nodes connected to each node from the first set of nodes based on a first weight and a second weight, associated with edges connecting the second set of nodes, and the polarity score associated with each node in the first set of nodes. Further, the one or more processors are configured to select a third set of nodes from the first set of nodes based on at least the polarity score associated with the second set of nodes connected to each node in the first set of nodes, wherein the third set of nodes represents the one or more target users.

According to the embodiments illustrated herein, there is provided a computer program product for use with a computing device. The computer program product comprises a non-transitory computer readable medium, the non-transitory computer readable medium stores a computer program code for identifying one or more target users, of a first content, from a social network. The computer readable program code is executable by a graph processor configured to generate a graph comprising one or more nodes and one or more edges connecting the one or more nodes. Each of the one or more nodes in the graph is representative of a user of the social network, and an edge, from the one or more edges in the graph, is representative of an acquaintance between a pair of nodes connected by the edge. The computer readable program code is further executable by one or more processors to determine a first score and a second score for each of the one or more nodes based on at least depth parameters associated with the graph. Further, the computer readable program code is executable by the one or more processors to select a first set of nodes from the one or more nodes based on at least one of the first score and the second score. The computer readable program code is further executable by the one or more processors to determine a polarity score for each node in the first set of nodes based on one or more actions performed by users, represented by the first set of nodes, on a second content, wherein the second content is similar to the first content. The computer readable program code is further executable by the one or more processors to determine the polarity score for each node in a second set of nodes connected to each node from the first set of nodes based on a first weight and a second weight, associated with edges connecting the second set of nodes, and the polarity score associated with each node in the first set of nodes. The computer readable program code is further executable by the one or more processors to select a third set of nodes from the first set of nodes based on at least the polarity score associated with the second set of nodes connected to each node in the first set of nodes, wherein the third set of nodes represents the one or more target users.

### BRIEF DESCRIPTION OF DRAWINGS

The accompanying drawings illustrate the various embodiments of systems, methods, and other aspects of the disclosure. Any person with ordinary skill in the art would appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is a block diagram illustrating a system environment in which various embodiments may be implemented;

FIG. 2 is a block diagram illustrating a system for identifying one or more target users in a social network, in accordance with at least one embodiment;

FIG. 3 is a flowchart illustrating a method for identifying one or more target users in a social network, in accordance with at least one embodiment;

FIG. 4A is a graph illustrating acquaintances between one or more users, in accordance with an embodiment;

FIG. 4B is a graph illustrating a modified graph, in accordance with an embodiment;

FIG. 5 is a flowchart illustrating a method for determining a first score, in accordance with at least one embodiment; and

FIG. 6 is a flowchart illustrating a method for determining a second score, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation, but that not every embodiment or example necessarily includes that particular feature, structure, characteristic, property, element, or limitation. Further, repeated use of the phrase “in an embodiment” does not necessarily refer to the same embodiment.

### DEFINITIONS

The following terms shall have, for the purposes of this application, the meanings set forth below.

A “computing device” refers to a device that includes one or more processors/microcontrollers and/or any other electronic components, or a device or a system that performs one or more operations according to one or more programming instructions/codes. Examples of the computing device may include, but are not limited to, a desktop computer, a laptop, a personal digital assistant (PDA), a mobile device, a Smartphone, a tablet computer (e.g., iPad®, and Samsung Galaxy Tab®), and the like.

A “social media platform” refers to a communication platform through which a user may interact with one or more other users who are known to or otherwise acquainted with the user. Further, apart from interacting with one another, the user and the one or more other users may perform one or more actions on the social media platform. In an embodiment, the one or more actions may include, but are not limited to, posting content or sharing content with the other users. Examples of social media platforms include, but are not limited to, social networking websites (e.g., FACEBOOK, TWITTER™, LINKEDIN, GOOGLE+™, and so forth), web-blogs, web-forums, community portals, online communities, or online interest groups. In an embodiment, the social media platform may be utilized for maximizing a spread of content. Hereinafter, the term “social media platform” may be interchangeably referred as “social network platform” or “social networking platform”.

A “requestor” refers to an individual, an advertiser, a sales person, or an artificial entity such as an organization, a political party, a business group, or a franchise. In an embodiment, the requestor may want to identify one or more users on the social network platforms, who may be interested in receiving a particular content. Further, in an embodiment, post identifying the one or more users, the requestor may transmit the content to the one or more users. In an embodiment, the content may correspond to, but is not limited to, one or more of one or more advertisements, personalized or community based recommendations for products and services, and election campaign management.

A “target user” refers to an individual who may be registered on the one or more social network platforms. The target user may interact with one or more other users of the one or more social network platforms who are known to or otherwise acquainted with him/her, by performing the one or more actions. In an embodiment, the target user may receive content from the requestor. The target user may further share the content with the other users. In an embodiment, the target user may influence the other users in his/her social circle on the one or more social network platforms in a positive manner or a negative manner towards the content. In an embodiment, the target user may correspond to the individual who can maximize the spread of the content among the one or more users of the one or more social network platforms.

A “graph” refers to an index that is representative of relationships between one or more users of the social network. The one or more users may be represented by the one or more nodes in the graph. The relationships between the one or more users may be represented by one or more edges. Each edge between a pair of nodes may be a representative of a connection between two nodes.

An “acquaintance” refers to a relationship between a plurality of users of the one or more social network platforms. In an embodiment, the plurality of users may be registered on one or more social network platforms. Further, in an embodiment, the relationship may correspond to one or more of, but is not limited to, a follower, a following, a friend, a friend of friend, and so on. Further, in an embodiment, a user may be acquainted to another user through one or more of, but not limited to, own group/guilds (e.g., friendship groups, family groups), same geographical area or vicinity, and past working history. In another embodiment, the users may be acquainted with each other directly or through other users (i.e., acquaintance of acquaintance, or transitive acquaintance). For example, a user “A” is acquainted to a user “B” and the user “B” is acquainted to a user “C”. Then, the user “A” is acquainted to the user “C” indirectly or transitively.

A “depth parameter” refers to a predetermined distance from a node in a graph. In an embodiment, if a second node is within the predetermined distance from a first node, a user represented by the second node may be considered to be acquainted with a user represented by the first node. In an embodiment, the depth parameter may further correspond to a number of hops from a node, or levels of the graph. For example, if the depth parameter of a graph is two, this may imply that users represented by nodes up to two levels from a given node may be considered as acquainted with a user represented by the given node.

“Metadata of content” refers to an additional data that may be transmitted along with the content. In an embodiment, the additional data may comprise, but is not limited to, a context of the content, a genre of the content, and a timeline associated with the content. In an embodiment, the content may correspond to a first content or a second content. In an embodiment, the first content may refer to a new content that may be required to be spread on the social network platforms. The first content may correspond to one or more of, but not limited to, a recommendation for products and services, an election campaign, and one or more advertisements or promotions. Further, the second content may refer to past content on which the one or more users of the social network platforms may have performed one or more actions. In an embodiment, the second content may be similar to the first content.

“One or more actions” refer to one or more activities performed on the second content by the one or more users. In an embodiment, the one or more actions may include, but are not limited to, sharing of the content, commenting on the content, posting a blog related to the content, and liking/disliking the content.

“Orientation of a user” refers to a personal inclination of the user towards an object or the content. The object may be a living or a non-living thing. In particular, the orientation of the user may correspond to one or more of, but not limited to, an attitude, a belief, or a feeling towards the object or the content. The orientation of the user may be positive or negative. The positive orientation implies that the user is positively inclined towards the object or the content. The negative orientation implies that the user is negatively inclined towards the object or the content. For example, a first user is a big fan of football and always posts/shares messages/images/videos related to football. A second user is acquainted with the first user. The second user may share/comment on the messages/images/videos posted by the first user, when the second user is positively orientated towards the first user. However, the second user may not share/comment on the messages/images/videos posted by the first user, when the second user is negatively orientated towards the first user. Further, the second user may dislike the posts/comments from the first user.

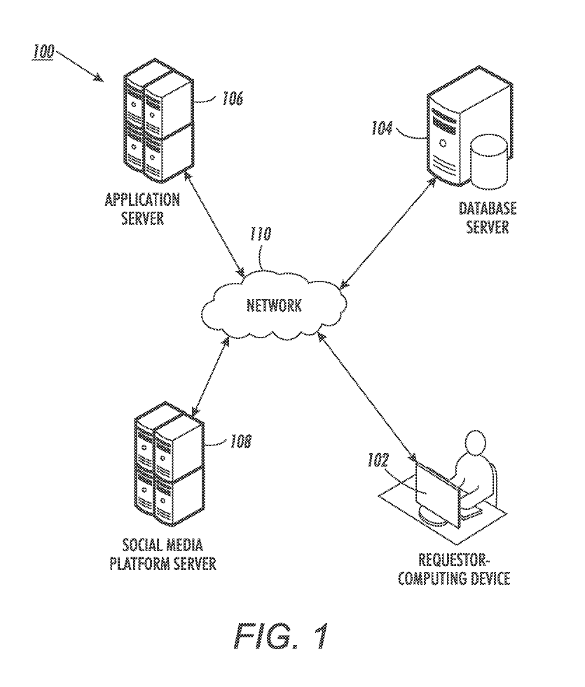

FIG. 1 is a block diagram of a system environment 100, in which various embodiments can be implemented. The system environment 100 includes a requestor-computing device 102, a database server 104, an application server 106, a social media platform server 108, and a network 110. Various devices in the system environment 100 may be interconnected over the network 110. FIG. 1 shows, for simplicity, one requestor-computing device 102, one database server 104, one application server 106, and one social media platform server 108. However, it will be apparent to a person having ordinary skill in the art that the disclosed embodiments may also be implemented using multiple user-computing devices 102, multiple database servers 104, multiple applications servers 106, and multiple social media platform servers 108.

The requestor-computing device 102 refers to a computing device used by a requestor. The requestor-computing device 102 may comprise one or more processors in communication with one or more memories. The requestor-computing device 102 may be operable to execute one or more sets of instructions stored in the one or more memories. In an embodiment, the requestor-computing device 102 may be communicatively coupled to the network 110. In an embodiment, the requestor-computing device 102 may comprise a display screen that may be configured to display one or more user interfaces to the requestor. In an embodiment, the requestor may utilize the requestor-computing device 102 to transmit or receive information, pertaining to an identification of one or more target users, to/from the database server 104 and/or the application server 106 over the network 110. For example, the requestor may input, using the requestor-computing device 102, a numerical value representing a number of target users needed to be identified on social network platforms. Further, the requestor may transmit metadata associated with a first content to the database server 104 or the application server 106. In an embodiment, the metadata associated with the first content may include a context of the first content, and a genre of the first content. In addition, the requestor may use the requestor-computing device 102 to transmit, to the application server 106, one or more graph parameters such as, but not limited to, a depth parameter that may be utilized for identifying the one or more target users. Further, in an embodiment, the requestor may be presented with a user interface on the display screen of the requestor-computing device 102 displaying a list of the one or more target users.

The requestor-computing device 102 may correspond to various types of computing devices such as, but not limited to, a desktop computer, a laptop, a personal digital assistant (PDA), a mobile device, a smartphone, a tablet computer (e.g., iPad® and Samsung Galaxy Tab®), and the like.

In an embodiment, the requestor may correspond to one or more of, but not limited to, an individual, an advertiser, a sales person, and an artificial entity (e.g., an organization, a political party, and a franchise) who may want to identify the one or more target users on the social network platforms. In an embodiment, post identifying the one or more target users, the requestor may use the requestor-computing device 102 to transmit the first content to the one or more target users. In an embodiment, the first content may correspond to a recommendation for products and services, an election campaign, and one or more advertisements or promotions.

The database server 104 may refer to a computing device that may store social network data pertaining to one or more users of the social network platforms such as FACEBOOK, LINKEDIN, TWITTER™, and the like, in accordance with at least one embodiment. The social network data pertaining to the one or more users may comprise one or more of, but not limited to, one or more attributes of user profiles associated with the one or more users, authentication details associated with the one or more users, and an acquaintance details associated with each of the one or more users. The one or more attributes pertaining to the user profiles may comprise at least one or more of, but are not limited to, a name, an occupational details, a biographical keywords, likes/dislikes, hobbies, and personal descriptions of the one or more user. The acquaintance details associated with each of the one or more users may comprise one or more of, but are not limited to, a follower, a following, a friend, a friend of a friend, and so on. In an embodiment, the database server 104 may receive a query, from the social media platform server 108, pertaining to retrieving the data. Further, the database server 104 may store a log of the one or more actions performed by each of the one or more users on the social network platforms. In an embodiment, the database server 104 may transmit a query to the social media platform server 108 to retrieve the logs of the one or more actions. In an embodiment, the one or more actions may include, but are not limited to, sharing of content, commenting on the content, posting a blog related to the content, and liking/disliking the content.

In an embodiment, the database server 104 may be communicatively coupled to the network 110. In an embodiment, the database server 104 may be configured to transmit or receive one or more instructions/information/social network data to/from one or more devices, such as the requestor-computing device 102, the application server 106, or the social media platform server 108 over the network 110. In an embodiment, the database server 104 may receive a query from the requestor-computing device 102 or the application server 106 to retrieve the information (e.g., the one or more attributes, the one or more user profiles, the network of acquaintances of each user, social network data, etc.) pertaining to the one or more users. For querying the database server 104, one or more querying languages may be utilized such as, but not limited to, SQL, QUEL, DMX and so forth. Further, the database server 104 may be realized through various technologies such as, but not limited to, Microsoft® SQL server, Oracle, and My SQL.

The application server 106 may refer to a computing device or a software framework that may provide a generalized approach to create the application server implementation. In an embodiment, the functions of the application server 106 may be dedicated to the efficient execution of procedures such as, but not limited to, programs, routines, or scripts stored in one or more memories for supporting its applied applications. In an embodiment, the application server 106 may receive the metadata pertaining to the first content. Further, the application server 106 may receive the one or more graph parameters such as the depth parameter from the requestor-computing device 102. Further, in an embodiment, the application server 106 may send a query to the database server 104 to extract the social network data pertaining to each of the one or more users of the social network platforms.

Further, in an embodiment, the application server 106 may be configured to generate a graph representing at least the acquaintances of the one or more users of the social network platforms. The graph comprises one or more nodes and one or more edges connecting the one or more nodes. Each of the one or more nodes in the graph is representative of a user, from the one or more users, on the social network platforms. In an embodiment, an edge, from the one or more edges in the graph, is representative of an acquaintance between a pair of nodes (i.e., between two users) connected by the edge. In an embodiment, the application server 106 is further configured to determine a first score and a second score for each of the one or more nodes in the graph (each node represents a user of the social network platforms). In an embodiment, the first score may correspond to a weighted sum of a number of reachable nodes from each node in the graph. In an embodiment, the number of reachable nodes may be determined based on the depth parameter (received from the requestor-computing device 102). Further, the second score may correspond to a weighted sum of a number of paths in the graph, where each path may be a sequence of at least one or more edges in the graph such that the length of the path is less than or equal to the depth parameter. Thereafter, the application server 106 may be configured to select a first set of nodes, from the one or more nodes of the graph, based on at least the first score and/or the second score associated with each of the one or more nodes. In an embodiment, a node, from the one or more nodes, having a maximum first score and/or a maximum second score, among the one or more nodes, may be selected as a first node in the first set of nodes. Thereafter, the application server 106 may disjoint the first node and the corresponding one or more reachable nodes from the graph. Thereafter, the application server 106 may again determine the first score and the second score for each node in the modified graph. Thereafter, the application server 106 may select a second node from the modified graph in a similar manner as discussed above. The application server 106 may repeat the process until the complete graph has been traversed.

Post determining the first set of nodes, the application server 106 is configured to determine a polarity score for each node in the first set of nodes. In an embodiment, the polarity score is determined based on the one or more actions performed on a second content by users (represented by the first set of nodes). In an embodiment, the second content may be similar to the first content. In an embodiment, the second content may correspond to a content on which the one or more users may have performed one or more actions in the past. The one or more actions on the second content may comprise at least one of, but not limited to, sharing/posting/tagging one or more messages/images related to the second content to one or more other users. The application server 106 is further configured to determine a polarity score for each node in a second set of nodes connected to each node in the first set of nodes. In an embodiment, the second set of nodes corresponds to the one or more reachable nodes (i.e. one or more acquainted users) associated with each node in the first set of nodes. The polarity score for each node in the second set of nodes is determined based on a first weight and a second weight, associated with edges connecting the second set of nodes with the respective nodes in the first set of nodes, and the polarity score associated with each node in the first set of nodes. The first weight associated with an edge corresponds to a measure of an influence of a user (represented as a node) on another user (represented by another node connected to the node by the edge). The second weight associated with the edge corresponds to likelihood that the other user, represented by the other node, may be influenced by the user (represented by the node) with same polarity, as that of the node, towards the content. Further, in an embodiment, the application server 106 is configured to select a third set of nodes from the first set of nodes based on at least the polarity score associated with the second set of nodes connected to the respective nodes in the first set of nodes. In an embodiment, the third set of nodes may represent the one or more target users. Further, in an embodiment, the application server 106 may present, on a graphical user interface (GUI) displayed on the display screen of the requestor-computing device 102, the list of the one or more target users identified on the social network.

The application server 106 may be realized using various technologies such as, but not limited to, Java application server, .NET Framework, PHP, Base4 application server, and Appaserver.

A person skilled in the art would understand that the scope of the disclosure should not be limited to the database server 104 or the application server 106 as a separate entity. In an embodiment, the functionalities of the database server 104 and the application server 106 may be combined into a single server without limiting the scope of the disclosure.

Further, a person skilled in the art will appreciate that the scope of the disclosure should not be limited to the requestor-computing device 102 and the application server 106 as separate entities. In an embodiment, the application server 106 may be realized as an application hosted on or running on the requestor-computing device 102 without departing from the spirit of the disclosure.

In an embodiment, the social media platform server 108 is configured to host one or more social network platforms such as, but not limited to, a social networking website (e.g., FACEBOOK, TWITTER™, LINKEDIN, GOOGLE+™, and so forth), a chat/messaging application, a web-blog, web-forums, a community portal, an online community, or an online interest group. In an embodiment, the one or more users may register on the one or more social network platforms. The social media platform server 108 may refer to a communication medium through which a user may interact with one or more other users, who are known to or otherwise acquainted with the user. Further, apart from interacting with one another, the user and the one or more other users may post one or more messages/images/videos on the social network platforms. Further, in an embodiment, each of the one or more users may share/tag the one or more messages/images/videos with the one or more other users on the social network platforms. Further, the one or more users may interact with one another in reference to the one or more messages/images/videos. Further, in an embodiment, the one or more users may perform one or more actions pertaining to the one or more contents on the social network platforms. The one or more actions may include, but are not limited to, sharing of a previous content, commenting on the previous content, and liking/disliking previous content.

In an embodiment, the social media platform server 108 may be realized through various web-based technologies such as, but not limited to, a Java web-framework, a .NET framework, a PHP framework, or any other web-application framework.

The network 110 corresponds to a medium through which content and messages flow between various devices of the system environment 100 (e.g., the requestor-computing device 102, the database server 104, the application server 106, and the social media platform server 108). Examples of the network 110 may include, but are not limited to, a Wireless Fidelity (Wi-Fi) network, a Wireless Area Network (WAN), a Local Area Network (LAN), or a Metropolitan Area Network (MAN). Various devices in the system environment 100 can connect to the network 110 in accordance with various wired and wireless communication protocols such as Transmission Control Protocol and Internet Protocol (TCP/IP), User Datagram Protocol (UDP), and 2G, 3G, or 4G communication protocols.

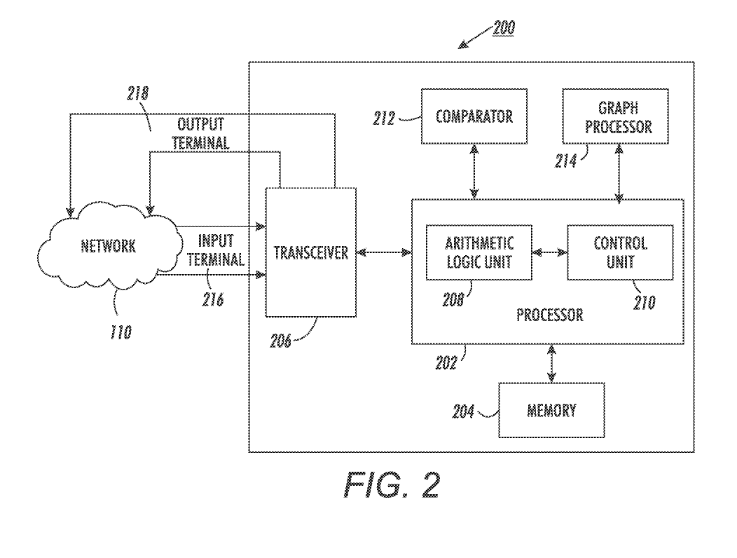

FIG. 2 is a block diagram illustrating a system 200 for identifying one or more target users in a social network, in accordance with at least one embodiment. The system 200 may comprise one or more processors, such as a processor 202, one or more memories, such as a memory 204, one or more transceivers, such as a transceiver 206, one or more comparator, such as a comparator 212, and one or more graph processors, such as a graph processor 214. The transceiver 206 is coupled with an input terminal 216 and an output terminal 218.

The system 200 may correspond to the requestor-computing device 102 or the application server 106 without departing from the scope of the disclosure. For the purpose of the ongoing description, the system 200 has been considered as the application server 106. However, a person skilled in the art will understand that the system 200 may be realized as the requestor-computing device 102 without departing from the spirit of the disclosure.

The processor 202 may be configured to execute a set of instructions stored in the memory 204 to perform one or more operations. The processor 202 may be coupled to the memory 204, the transceiver 206, the comparator 212, and the graph processor 214. The processor 202 may comprise one or more arithmetic logic units such as an arithmetic logic unit (ALU) 208 and one or more control units such as a control unit 210. The ALU 208 may be coupled to the control unit 210. The ALU 208 may be operable to perform one or more mathematical and logical operations and the control unit 210 may be configured to control the operation of the ALU 208. Though, the ALU 208 and the control unit 210 are implemented within the processor 202 in FIG. 2, a person skilled in the art would appreciate that the ALU 208 and the control unit 210 may be implemented independently from the processor 202 without departing from the scope of the disclosure. The processor 202 may be implemented based on a number of processor technologies known in the art. Examples of the processor 202 include, but are not limited to, an X86-based processor, a Reduced Instruction Set Computing (RISC) processor, an Application-Specific Integrated Circuit (ASIC) processor, and/or a Complex Instruction Set Computing (CISC) processor.

The memory 204 may be operable to store one or more machine codes, and/or computer programs having at least one code section executable by the processor 202. The memory 204 may store one or more sets of instructions/queries or information associated with the one or more users. Some of the commonly known memory implementations include, but are not limited to, a random access memory (RAM), a read-only memory (ROM), a hard disk drive (HDD), and a secure digital (SD) card. In an embodiment, the memory 204 may include the one or more machine codes, and/or computer programs that are executable by the processor 202 to perform specific operations. It will be apparent to a person having ordinary skill in the art that the one or more instructions stored in the memory 204 enables the hardware of the system 200 to perform the predetermined operation.

The transceiver 206 may be operable to communicate with the one or more devices, such as the requestor-computing device 102, and/or one or more servers, such as the database server 104 or the social media platform server 108 over the network 110. The transceiver 206 may be operable to transmit or receive the instructions/queries/social network data or other information to/from various components of the system environment 100. In an embodiment, the transceiver 206 is coupled to the input terminal 216 and the output terminal 218 through which the transceiver 206 may receive or transmit instructions/queries/social network data or other information corresponding to the identification of the one or more target users on the social network platforms. In an embodiment, the input terminal 216 and the output terminal 218 may be realized through, but not limited to, an antenna, an Ethernet port, an USB port or any other port that can be configured to receive and transmit data. The transceiver 206 may receive and transmit various data in accordance with various communication protocols such as, TCP/IP, UDP, and 2G, 3G, or 4G communication protocols through the input terminal 216 and the output terminal 218, respectively.

The comparator 212 is configured to compare at least two input signals to generate an output signal. In an embodiment, the output signal may correspond to either “1” or “0.” In an embodiment, the comparator 212 may generate output “1” if the value of a first signal (from the at least two signals) is greater than a value of the second signal (from the at least two signals). Similarly, the comparator 212 may generate an output “0” if the value of the first signal is less than the value of the second signal. In an embodiment, the comparator 212 may be realized through either software technologies or hardware technologies known in the art. Though, the comparator 212 is depicted as independent from the processor 202 in FIG. 2, a person skilled in the art would appreciate that the comparator 212 may be implemented within the processor 202 without departing from the scope of the disclosure.

The graph processor 214 may be configured to execute a set of instructions stored in the memory 204 to perform one or more predetermined operations. In an embodiment, the graph processor 214 may comprise suitable logic, circuitry, and/or interfaces that may be operable to execute one or more instructions stored in the memory 204 to generate the graph. In an embodiment, the graph processor 214 may utilize the acquaintance details of the one or more users of the social network platform, stored in the database server 104 or the memory 204, to generate the graph. Further, in an embodiment, the graph processor 214 may be configured to represent each user of the social network platforms with a node in the graph and acquaintances between each pair of nodes as each edge between the pair of nodes. The graph processor 214 may be implemented using one or more processor technologies known in the art. Examples of the graph processor 214 include, but are not limited to, an x86 microprocessor, an ARM microprocessor, an X86-based processor, a Reduced Instruction Set Computing (RISC) processor, an Application-Specific Integrated Circuit (ASIC) processor, and/or a Complex Instruction Set Computing (CISC) processor.

A person skilled in the art would understand that the scope of the disclosure should not be limited to the processor 202 and the graph processor 214 as separate entities. In an embodiment, the functionalities of the processor 202 and the graph processor 214 may be combined into a single processor without limiting the scope of the disclosure.

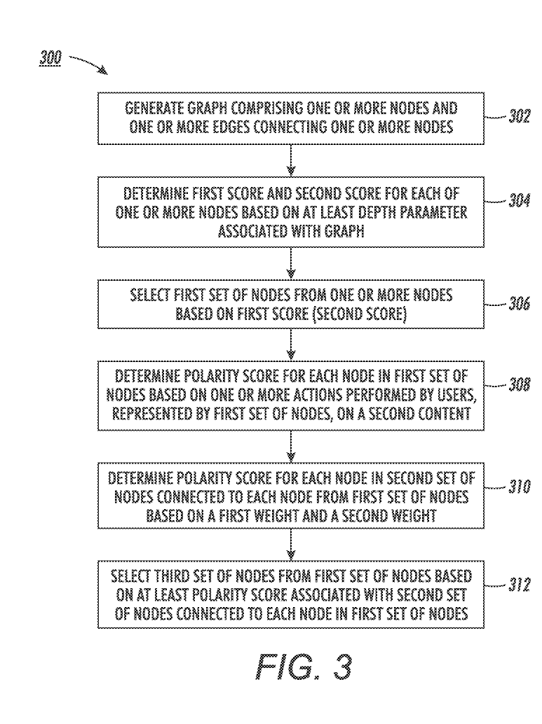

FIG. 3 is a flowchart 300 illustrating a method for identifying the one or more target users in the social network, in accordance with at least one embodiment. The flowchart 300 is described in conjunction with FIG. 1 and FIG. 2.

At step 302, a graph comprising the one or more nodes and the one or more edges connecting the one or more nodes is generated. In an embodiment, the graph processor 214 may be configured to generate the graph based on at least the social network data associated with the one or more users of the social network platforms. Prior to the generation of the graph, the processor 202 may receive a request from the requestor-computing device 102 for the identification of the one or more target users of the social media platform. The request may include the numerical value representing a count of such target users, the metadata related to the first content, and the one or more graph parameters. Post receiving the request, the processor 202 may send a query to the database server 104 or the memory 204 to extract the social network data associated with the one or more users of the social network platforms. The social network data associated with each user may comprise, but is not limited to, the one or more attributes of the user profiles associated with the one or more users, the authentication details associated with the one or more users, and the acquaintance details associated with each of the one or more users. For example, the one or more attributes may comprise one or more of, but not limited to, the name, occupational details, biographical keywords, likes/dislikes, hobbies, and personal descriptions of the one or more users. The acquaintance details may comprise one or more of, but not limited to, a connection between two users such as a follower, a following, a friend, a friend of a friend, and so on, and a relationship between two users such as connected by blood, marriage, adoption, and the like.

Once the social networking data is extracted, the graph processor 214 may generate the graph. The graph comprises the one or more nodes and the one or more edges. The one or more nodes in the graph are representative of the one or more users of the social network platforms. The edge between a pair of the nodes (i.e., between two users) is representative of the acquaintance between the two users from the one or more users.

A person having ordinary skill in the art would understand that the scope of the disclosure is not limited to the graph representing only direct acquaintance between two users. In an embodiment, the graph may further be representative of indirect acquaintances between the two users, for example, friends of friends may be considered as an indirect acquaintance.

Further, a person having ordinary skill in the art would understand that the scope of the disclosure is not limited to the graph being generated based on the acquaintance between the one or more users. In an embodiment, the graph may further be created based on the common interests of the one or more users. In such a scenario, the graph processor 214 may place an edge between two nodes (each node represents a user), when there are common interests such as football or Hollywood movies between the two users.

Further, in an embodiment, the generated graph may be a directed graph, wherein each edge between a pair of nodes may be a directed edge. In an embodiment, the direction of an edge from one node (i.e., one user) to another node (i.e., another user) may be representative of one or more of, but not limited to, a follower, a following, a friend, and a friend of friend. For example, a second user is following a first user on a social network platform such as TWITTER™. In such a scenario, a direction of an edge, in the graph, is from the first user to the second user. However, a person skilled in the art would understand that the scope of the disclosure is not limited to such an example scenario. In an embodiment, if the second user is following the first user on the social network platforms, the edge between the two users may be directed from the second user to the first user, without departing from the scope of the disclosure.

Post generating the graph, the processor 202 may be configured to determine an orientation of each of the one or more users (represented by the one or more nodes in the graph) towards the first content. In an embodiment, the ALU 208 is configured to determine the orientation for each node based on historical data associated with each respective user. In an embodiment, the orientation of a user corresponds to a score assigned to the user in the range of −1 to +1, where −1 represents a negative orientation of the user towards the content. Further, the +1 represents positive orientation of the user towards the content. In an embodiment, the orientation of the user is independent of orientation of the other users in the social network.

In order to determine the orientation of the user (represented by the node in the graph), the processor 202 may extract the historical data associated with user from the database server 104. The historical data may comprise the log of the one or more actions performed by the users on the second content. In an embodiment, the second content may be similar to the first content. For example, if the first content relates to sport shoes, the second content is also related to the sports shoes. In an embodiment, the second content may correspond to a content on which the user may have performed one or more actions in the past. The one or more actions on the second content may comprise at least one of, but not limited to, sharing/posting/tagging/recommending one or more messages/images/videos related to the second content to the one or more other users. The processor 202 may utilize the log of the one or more actions on the second content to determine the orientation of the node representing the user. For example, the user has shared the second content with other users with a positive intent. In an embodiment, the positive intent of the user may be determined based on the comments that the user has provided on the second content. In an embodiment, the processor 202 may perform sentiment analysis on the comment to determine the intent. In an embodiment, the intent may be positive or negative. Based on the intent, the processor 202 may determine the orientation of the user.

A person having ordinary skill in the art would understand that the scope of the disclosure is not limited to determining the intent only through the comments that the user has provided on the second content. In an embodiment, the orientation of the user may be determined based on the attributes of the user profile. For example, if the user is interested in sports and the second content is related to sports shoes, the processor 202 may determine that there is high likelihood that the user may be positively oriented towards the second content. In another embodiment, the one or more actions such as sharing the second content may be considered as a positive intent of the user towards the second content, when no comments are provided by the user. In another embodiment, the orientation of the user may further be determined based on the type of content being shared by the user. For example, the user sharing content that is against a particular political party. Therefore, the user may have a negative orientation towards the first content, if the first content conveys positive aspects of the political party under consideration.

In an embodiment, the processor 202 may utilize any known sentiment analysis technique to determine the orientation of the user. Post determining the orientation of each of the one or more users towards the first content, the processor 202 may assign the orientation score to the respective one or more nodes in the graph.

The processor 202 may determine, for each of the one or more edges, a first weight and a second weight. In an embodiment, the first weight (P_{u,v}) corresponds to a measure of an influence of the user (represented by a node u) on the other users (represented by the other node v connected to the node u by an edge). The second weight (w_{u,v}) associated with the edge corresponds to a likelihood that the other user (represented by the other node v), is influenced with same orientation as that of the user (represented by the node u). In an embodiment, the processor 202 may determine the first weight (P_{u,v}) and the second weight (W_{u,v}) associated with each edge (e.g., an edge between nodes u, v) based on at least the log of the one or more actions performed by the users (e.g., the users who are represented by the nodes u, v) on the second content.

For example, from the logs of the one or more actions, the processor 202 determines that out of ten content shared by the first user, the second user (connected to the first user) has further shared 7 content. Therefore, the first weight associated with the edge connecting the first user and the second user is 0.7 (i.e., a ratio of a number of contents of the first user shared by the second user). Similarly, the processor 202 may analyze the comments provided by the second user on the content shared by the first user to determine the second weight. For example, the processor 202 determines that out of seven contents, the second user has provided positive comments on only three contents. Therefore, second weight assigned to the edge is 0.4.

In an embodiment, the first and the second weights may vary based on the metadata of the first content. For example, if the first content relates to sports, then the weights are assigned based on the action performed by the first user and the second user with respect to the sports content.

In an embodiment, in the absence of the historical data, the processor 202 may assign a predefined value (or a random value) to each of the first weight and the second weight corresponding to each edge of the graph.

At step 304, a first score and a second score is determined for each of the one or more nodes in the graph. In an embodiment, the ALU 208 may determine the first score and the second score. In an embodiment, the first score corresponds to a reach score that is representative of the weighted sum of the number of reachable nodes from each of the one or more nodes. In an embodiment, the second score corresponds to a path score that is representative of the weighted sum of the number of paths in the graph, where each path may be a sequence of at least one or more edges in the graph such that the length of the path is less than or equal to the depth parameter.

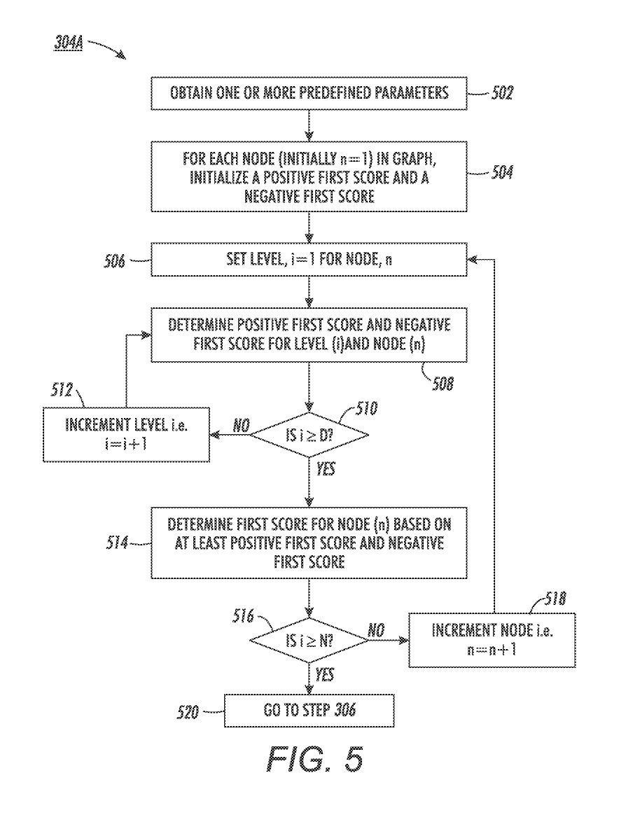

The first score for each node is determined based on at least the depth parameters associated with the graph. In an embodiment, the ALU 208 may be configured to determine the first score for each of the one or more nodes of the graph. The first score, for each node, is determined based on at least the depth parameter, number of nodes having either a positive orientation or a negative orientation, towards the first content, at each of one or more levels of the graph, and the one or more predefined parameters such as a decay factor corresponding to the one or more levels of the graph. In an embodiment, the decay factor may be indicative of a decreasing influence of the one or more users with an increase in the level of the graph. For example, an influence of a user on one or more followers of the user may be greater than the influence of the user on one or more second level followers (i.e., indirect followers) of the user, and so on. The determination of the first score will be explained later in conjunction with the FIG. 5.

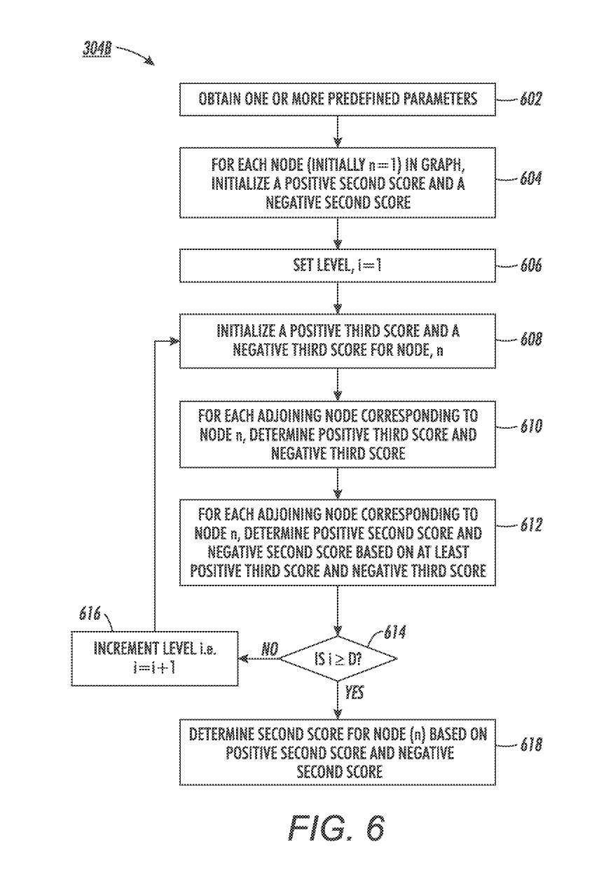

In an embodiment, the ALU 208 may be further configured to determine the second score for each of the one or more nodes of the graph. The second score, for each node, is determined based on at least the depth parameter, the number of paths, a number of neighboring nodes having either a positive orientation or negative orientation, and the one or more predefined parameters such as the decay factor corresponding to the one or more levels of the graph. The determination of the second score will be explained later in conjunction with the FIG. 6.

At step 306, the first set of nodes is selected, from the one or more nodes of the graph, based on the first score associated with each of the one or more nodes. In an embodiment, the processor 202 may be configured to select the first set of nodes based on at least the first score associated with each of the one or more nodes of the graph. Firstly, the processor 202 may select a node from the one or more nodes of the graph. Thereafter, the comparator 212 may compare the first score of the selected node with the first score of each of the remaining one or more nodes of the graph. In case, the first score of the selected node is greater than the first score of each of the remaining one or more nodes, the processor 202 may consider the selected node as the first set of nodes. However, in case, the first score of the selected node is less than the first score of at least one of the remaining one or more nodes, the processor 202 may select another node from the one or more nodes of the graph. Thereafter, the processor 202 may repeat the process as discussed above until the processor 202 identifies a node having a maximum first score among the one or more nodes of the graph. In an embodiment, the processor 202 considers the node, having the maximum first score, as a first node of the first set of nodes. Thereafter, the processor 202 may determine the second set of nodes associated with the selected first node. In an embodiment, the second set of nodes is one or more reachable nodes from the first node. In an embodiment, the processor 202 determines the second set of nodes based on the depth parameter. Post selecting the second set of nodes, the processor 202 may remove the first node and the associated second set of nodes from the graph to generate a modified graph. Post determining the first node, the processor 202 may be configured to select a second node in a similar manner that the processor 202 employed to identify the first node.

As the selected node (e.g., the first node) and the corresponding one or more reachable nodes are removed from the graph, therefore there may not be an overlap between the selected first set of nodes and the corresponding second set of nodes. This may result in saving of a computation cost (i.e., number of iterations). In an embodiment, the first set of nodes corresponds to seed nodes.

In another embodiment, the processor 202 may select the first set of nodes, from the one or more nodes of the graph, based on at least the second score associated with each of the one or more nodes. In an embodiment, the processor 202 may select the first set of nodes based on the second score in the same manner as discussed above based on the first score.

Further, a person skilled in the art will appreciate that the scope of the disclosure should not be limited to the determination of the first set of nodes based on the first score and the second score as separate entities. In an embodiment, the processor 202 may be configured to determine the first set of nodes based on at least a third score associated with each of the one or more nodes of the graph without departing from the spirit of the disclosure. The ALU 208 may determine the third score based on at least the first score and the second score. In an embodiment, the ALU 208 may perform one or more operations using the first score and the second score to obtain the third score. The one or more operations may comprise at least one or more of, but not limited to, an addition, a subtraction, a multiplication, a division, a mean, a median, a maxima, a minimal, or any other mathematical operations.

At step 308, the polarity score for each node in the first set of nodes is determined. In an embodiment, the processor 202 may be configured to determine the polarity score, for each node in the first set of nodes. As discussed in conjunction with step 302, the processor 202 determines the orientation of each of the one or more users towards the first content. In an embodiment, the processor 202 may consider the polarity score of the first set of nodes same as the orientation of the users (represented by the first set of nodes in the graph) towards the first content. In an embodiment, the polarity score of each node is representative of a personal orientation of each user (represented by each node) towards the first content. For example, a polarity score of a node u is denoted by Oᵤε[−1,1]. Here, −1 is representative of a strong negative polarity of a user (represented by the node u) towards a first content and +1 is representative of a strong positive polarity of the user (represented by the node u) towards the first content.

At step 310, the polarity score for each node in the second set of nodes is determined. In an embodiment, the second set of nodes may correspond to the one or more reachable nodes (i.e., the one or more acquaintance nodes) associated with a node in the first set of nodes. In an embodiment, the processor 202 may be configured to determine the polarity score of each node in the second set of nodes based on at least the first weight and the second weight associated with the edge connecting a second node with the first node, and the polarity score associated with the nodes in the first set of nodes.

As discussed in conjunction with step 302, each edge (e.g. an edge between the nodes u, v) has associated first weight (P_{u,v}) and the second weight (W_{u,v}). Further, the processor 202 may utilize the following equation to determine the polarity score of the node v in the second set of nodes connected to the node u in the first set of nodes:

P_{score}=Σₒ_{ᵤ}_{≧0}Oᵤ*(2*W_{u,v}−1)+Σₒ_{ᵤ}_{<o}Oᵤ*(1−2*W_{u,v}) (1)

where,
P_{score}: Polarity score of the node v in the second set of nodes;
Oᵤ: Polarity score of the node u towards a first content; and
W_{u,v}: Second score for an edge between the nodes u, v.

Post determining the polarity score of each node in the second set of nodes, the processor 202 normalizes the polarity score P_{score} to lie in the range [−1,1]. In an embodiment, the polarity score P_{score} may be representative of an influence of the neighboring node u on the node v. Further, in an embodiment, the processor 202 may determine a final polarity score of a node v based on at least the polarity score P_{score} and the orientation of the user (represented by node v) towards the first content.

At step 312, the third set of nodes is selected from the first set of nodes. In an embodiment, the processor 202 may select the third set of nodes from the first set of nodes based on the polarity score associated with each node in the respective second set of nodes. For example, the first set of nodes comprises a first node and a second node. Each of the first node and the second node has associated second set of nodes. For instance, the second set of nodes, connected to the first node, comprises three nodes. Similarly, the second set of nodes, connected to the second node, comprises four nodes. The cumulative polarity of the first node the corresponding connected second set of nodes is 0.4. Further, the cumulative polarity of the second node and the corresponding second set of nodes is −0.1. Therefore, the processor 202 may select the first node as the third set of nodes, as the first node and corresponding second set of nodes are maximizing the spread of content with a positive intent/orientation. In an embodiment, the processor 202 may determine the cumulative polarity by adding individual polarity score of the seed node and corresponding second set of nodes. In an embodiment, the third set of nodes comprises one or more nodes, wherein each node represents a target user. Further, in an embodiment, the processor 202 may present, on the GUI displayed on the display screen of the requestor-computing device 102, the list of the one or more target users identified on the social network platforms, which may be reached for maximizing the spread of the first content on the social network platforms.

Post the identification of the one or more target users, the requestor may transmit the first content to the one or more target users using the requestor-computing device 102. The one or more target users may post/share one or more messages/images/videos corresponding to the first content. One or more users, who have received the first content from the target users, may further like/comment/share the first content. In this way, the information pertaining to the first content may be spread among one or more users of the social network platforms.

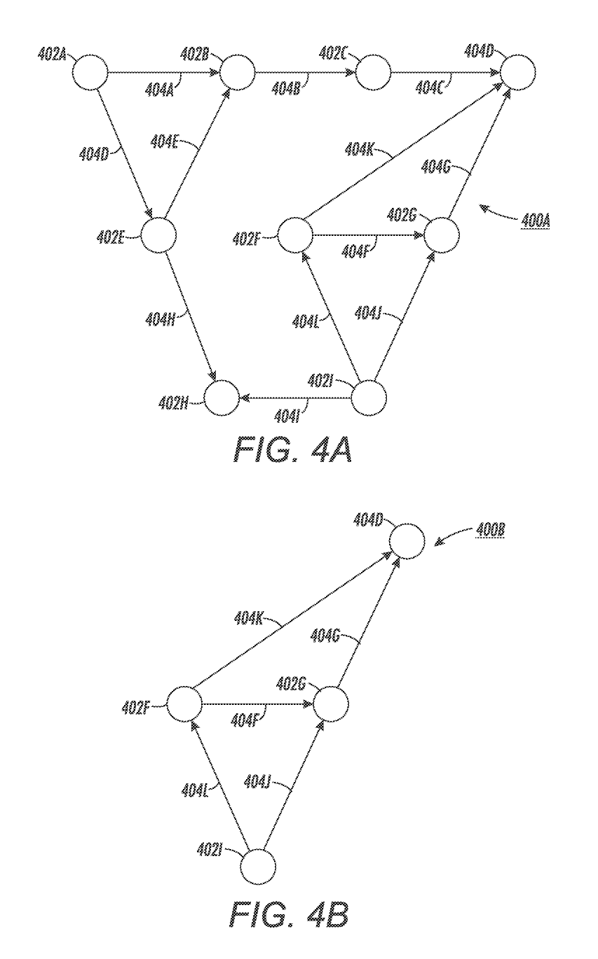

FIG. 4A is a graph 400A illustrating acquaintances between the one or more users, in accordance with an embodiment. The graph 400A is described in conjunction with FIG. 1, FIG. 2, and FIG. 3.

In an embodiment, the graph 400A may comprise plurality of nodes, such as nodes 402a, 402b, 402c, 402d, 402e, 402f, 402g, 402h, and 402i. In an embodiment, each node in the graph 400A may represent a user of the social network platform. In an embodiment, the graph 400A may comprise plurality of edges, such as edges 404a, 404b, 404c, 404d, 404e, 404f, 404g, 404h, 404i, 404j, 404k, and 404l. In an embodiment, each edge may represent an acquaintance/link/connection/relationship between two users. In an embodiment, the graph processor 214 may generate the graph 400A representative of the acquaintances between the one or more users of the social network platforms. As discussed, the graph processor 214 may utilize the social network data pertaining to the one or more users to generate the graph 400A. The graph processor 214 may utilize the extracted social network data to determine the acquaintances between the users. Based on the identified acquaintances, the graph processor 214 may place edges between different nodes (that represent the users) to generate the graph 400A. For example, if the graph processor 214 determines that two users (e.g., user A represented by node 402a and user B represented by node 402b) are acquainted, then the graph processor 214 may join the two users A and B by a single edge 404a as shown in FIG. 4A. If the graph processor 214 determines that two users (e.g., user A represented by node 402a and user G represented by node 402g) are not known to each other, then the graph processor 214 may not join the two users A and G as shown in FIG. 4A.

Post generating the graph, the processor 202 may assign the first score (or the second score) to each of the one or more nodes of the graph 400A. In an embodiment, the ALU 208 may be configured to determine the first score/second score associated with each node. In an embodiment, the node, from the one or more nodes, having the maximum first score (or the maximum second score) may be selected as the first node of the first set of nodes.

FIG. 4B is a graph 400B illustrating the modified graph, in accordance with an embodiment. The graph 400B is described in conjunction with FIG. 1, FIG. 2, FIG. 3, and FIG. 4A.

Post selecting the first node, the graph processor 214 may be configured to generate the modified graph 400B. In an embodiment, the modified graph 400B may not comprise the first node and the corresponding one or more reachable nodes (i.e., the acquaintance nodes of the first nodes up to a predefined level of the graph). For example, the processor 202 selects a node (represented by 402A) as a first node of the first set of nodes based on the first score (or the second score). The acquaintance nodes of the first node in the graph 400A for a predefined depth parameter (e.g., D=2) are nodes represented by 402b, 402c, 402e, and 402h. In such a scenario, the graph processor 214 may not include the nodes represented by 402a, 402b, 402c, 402e, and 402h in the modified graph 400B as shown in FIG. 4B. Post the generation of the modified graph 400B, the processor 202 selects the second node of the first set of node in a similar manner as discussed above for selecting the first node. In an embodiment, the processor 202 may repeat the process until the complete graph has been traversed. In another embodiment, the processor 202 may repeat the process until the desired first set of nodes is obtained.

FIG. 5 is a flowchart 304 illustrating a method for determining the first score, in accordance with at least one embodiment. The flowchart 304 is described in conjunction with FIG. 1, FIG. 2, and FIG. 3.

At step 502, the one or more predefined parameters are obtained from the requestor-computing device 102. In an embodiment, the processor 202 is configured to receive the one or more predefined parameters from the requestor-computing device 102. In an alternate embodiment, the processor 202 may extract the one or more predefined parameters from the database server 104 or the memory 204. The one or more predefined parameters comprise one or more of, but not limited to, the depth parameter (D) associated with the graph, the orientation of each node in the graph, and the decay factor (ρᵢ) corresponding to a level (i) of the graph.

At step 504, a positive first score (FS₊(n)) and a negative first score (FS₋(n)) for a node n in the graph are initialized. In an embodiment, the processor 202 may initialize the value of the positive first score (FS₊(n)) and the negative first score (FS₋(n)). For example,

FS₊(n)=0; and

FS₋(n)=0.

At step 506, a level (i) of the graph is initialized. In an embodiment, the processor 202 may initialize the level (i) to one, i.e., i=1. The maximum count of the level i is equal to the depth parameter D associated with the graph.

At step 508, the positive first score (FS₊(n)) and the negative first score (FS₋(n)) are determined for a node n at the level i of the graph. In an embodiment, the processor 202 may utilize the following equation to determine the positive first score (FS₊(n)) and the negative first score (FS₋(n)) for the node n at the level i:

FS₊(n)=FS₊(n)+ρᵢ*BFSlevel_{+,n,i} (2)

FS₋(n)=FS₋(n)+ρᵢ*BFSlevel_{-,n,i} (3)

where,

BFSlevel_{+,n,i}: Number of nodes at level i with positive orientation rooted to node n; and

BFSlevel_{-,n,i}: Number of nodes at level i with negative orientation rooted to node n.

At step 510, a check is performed to determine if the count of the level (i) is greater than or equal to the depth parameter (D). In an embodiment, the comparator 212 may perform the check. If at step 510, the comparator 212 determines that count of the level (i) is less than the depth parameter (D), then step 512 is performed. If at step 510, the comparator 212 determines that count of the level (i) is greater than or equal to the depth parameter (D), then step 514 is performed.

At step 512, the level i is incremented. In an embodiment, the processor 202 may utilize the following equation to increase the level i:

i=i+1 (4)

Post incrementing the level, the processor 202 may repeat process described at step 508 until the processor 202 determines that the count of the level (i) is greater than or equal to the depth parameter (D).

At step 514, the first score is determined for the node n based on at least the positive first score (FS₊(n)) and the negative first score (FS₋(n)). In an embodiment, the processor 202 may determine the first score FS(n) for the node n based on the positive first score FS₊(n), and the negative first score FS₋(n) for the node n at the level i=D. In an embodiment, the processor 202 may utilize the following equation to determine the first score for the node n:

FS(n)=FS₊(n)−(β*FS₋(n)) (5)

where,

β: Predefined parameter representing a penalty on negative nodes in the activated set.

At step 516, a check is performed to determine if the count of the nodes (n) is greater than or equal to the total count of the nodes in the graph (N). In an embodiment, the comparator 212 may perform the check. If at step 516, the comparator 212 determines that n≦N, then step 518 is performed. If at step 516, the comparator 212 determines that n≧N, then step 520 is performed.

At step 518, the node n is incremented. In an embodiment, the processor 202 may utilize the following equation to increment the count of node n:

n=n+1 (6)

Post incrementing the count of the node n (e.g., from n=1 to n=2), the processor 202 may determine the first score corresponding to the node n=2. In an embodiment, the processor 202 may repeat the above discussed process (step 502 to step 518) in any sequence or order to determine the first score associated with each node of the graph without limiting the scope of the disclosure.

At step 520, the processor 202 may perform the step 306, in a manner similar to that described in conjunction with FIG. 3.

FIG. 6 is a flowchart 304B illustrating a method for determining the second score, in accordance with at least one embodiment. The flowchart 304B is described in conjunction with FIG. 1, FIG. 2, and FIG. 3.

At step 602, the one or more predefined parameters are obtained from the requestor-computing device 102. In an embodiment, the processor 202 is configured to receive the one or more predefined parameters from the requestor-computing device 102. In an embodiment, the processor 202 may extract the one or more predefined parameters from the database server 104 or the memory 204. The one or more predefined parameters comprise one or more of, but not limited to, the depth parameter (D) associated with the graph, the orientation of each node in the graph, and the decay factor (ρᵢ) corresponding to a level (i) of the graph.

At step 604, a positive second score (SS₊(n)) and a negative second score (SS₋(n)) for a node n in the graph are initialized. In an embodiment, the processor 202 may initialize the initial value of the positive second score (SS₊(n)) and the negative second score (SS₋(n)) for the node n based on a predefined value. For example,

SS₊(n,i−1)=0; and

SS₋(n,i−1)=0.

At step 606, the level (i) of the graph is initialized. In an embodiment, the processor 202 may initialize the level (i) to one, i.e., i=1. The maximum count of the level i is equal to the depth parameter D associated with the graph.

At step 608, a positive third score (TS₊(n)) and a negative third score (TS₋(n)) for a node n of the graph are initialized. In an embodiment, the processor 202 may assign the initial value to the positive third score (TS₊(n)) and the negative third score (TS₋(n)) for the node n based on a predefined value. For example,

TS₊(n)=0; and

TS₋(n)=0.

At step 610, the positive third score (TS₊(n)) and the negative third score (TS₋(n)) are determined for each node adjacent to the node n at the level i. In an embodiment, the processor 202 may utilize the following equation to determine the positive third score (TS₊(n)) and the negative third score (TS₋(n)) for each node adjacent to the node n at the level i:

TS₊(n)=TS₊(n)+SS₊(n,i−1) (7)

TS₋(n)=TS₋(n)+SS₋(n,i−1) (8)

At step 612, the positive second score (SS₊(n)) and the negative second score (SS₋(n)) are determined for each node adjacent to the node n at the level i. In an embodiment, the processor 202 may utilize the following equation to determine the positive second score (SS₊(n)) and the negative second score (SS₋(n)) for each node adjacent to the node n at the level i:

SS₊(n)=(TS₊(n)*ρᵢ)+deg₊(n) (9)

SS₋(n)=(TS₋(n)*ρᵢ)+deg₋(n) (10)

where,

deg₊(n): Number of nodes adjacent to node n with positive orientation; and

deg₋(n): Number of nodes adjacent to node n with negative orientation.

At step 614, a check is performed to determine if the count of the level (i) is greater than or equal to the depth parameters (D). In an embodiment, the comparator 212 may perform the check. If at step 614, the comparator 212 determines that count of the level (i) is less than the depth parameters (D), then step 616 is performed. If at step 614, the comparator 212 determines that count of the level (i) is greater than or equal to the depth parameters (D), then step 618 is performed.

At step 616, the level i is incremented. In an embodiment, the processor 202 may utilize the equation 4 to increase the level i.

Post incrementing the level, the processor 202 may repeat process described above (step 608 to step 612) until the processor 202 determines that the count of the level (i) is greater than or equal to the depth parameters (D).

At step 618, the second score is determined for the node n based on at least the positive second score (SS₊(n)) and the negative second score (SS₋(n)). In an embodiment, the processor 202 may determine the second score SS(n) for the node n based on the positive second score SS₊(n), and the negative second score SS₋(n) for the node n at the level i=D. In an embodiment, the processor 202 may utilize the following equation to determine the second score for the node n:

SS(n)=SS₊(n,D)−*(β*SS₋(n,D)) (11)

where,

β: Predefined parameter representing a penalty on negative nodes in the activated set.

A person having ordinary skills in the art would understand that the method for determining the first score (or the second score) is not limited to the sequence of steps as described in FIG. 5 (or FIG. 6). The steps may be processed in any sequence to determine the first score (or the second score).

Various embodiments of the disclosure lead to a method and a system for identifying the one or more target users for the one or more first contents. The method utilizes the details of acquaintances between the one or more users of the social network platforms to generate the graph. The graph is a weighted directed graph, where each edge between a pair of nodes represents the probability with which a node (i.e., one user) can influence the other node (i.e., other user). The disclosed method further selects one or more seed users (i.e., the first set of users) based on the first score and/or the second score associated with one or more nodes of the graph. As discussed, as the one or more seed users correspond to users who have higher first/second scores than the other users in the graph, the one or more seed users may have a greater influence on their acquaintances than the other users. The disclosed method further utilizes the past orientation of the one or more users of the social network platforms towards the second contents to identify the one or more target users. The one or more target users may be reached for maximizing the spread of the one or more first contents on the social network platforms. The one or more first contents may correspond to various applications, namely, personalized/community based product recommendations, advertisement targeting, marketing, estimating the propagation of diseases to model epidemics, mining the trending topics, predicting election results or for that matter planning election campaigns, etc. The first content may be propagated to the users of the social network platforms through the influence of the one or more target users on their first level acquaintances, second level acquaintances, and so forth. Hence, an organization which needs to spread the first content to the users of the social network platform may save on costs by sending the first content only to the one or more target users.

The disclosed methods and systems, as illustrated in the ongoing description or any of its components, may be embodied in the form of a computer system. Typical examples of a computer system include a general purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or similar devices that enable the computer system to connect to databases and networks such as LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks such as steps that constitute the method of the disclosure. The systems and methods described can also be implemented using only software programming, only hardware, or a varying combination of the two techniques. The disclosure is independent of the programming language and the operating system used in the computers. The instructions for the disclosure can be written in all programming languages including, but not limited to, “C,” “C++,” “Visual C++,” and “Visual Basic.” Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, “Unix,” “DOS,” “Android,” “Symbian,” and “Linux.”

The programmable instructions can be stored and transmitted on a computer-readable medium. The disclosure can also be embodied in a computer program product comprising a computer-readable medium, with any product capable of implementing the above methods and systems, or the numerous possible variations thereof.

Various embodiments of the methods and systems for identifying one or more target users on a social network have been disclosed. However, it should be apparent to those skilled in the art that modifications, in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art that are also intended to be encompassed by the following claims.

What is claimed is:

1. A method for identifying one or more target users, of a first content, from a social network, said method comprising:
generating, by a graph processor, a graph comprising one or more nodes and one or more edges connecting said one or more nodes, wherein each of said one or more nodes is representative of a user of said social network, and wherein an edge, from said one or more edges, is representative of an acquaintance between a pair of nodes connected by said edge;
determining, by an arithmetic logic unit in one or more processors, a first score and a second score for each of said one or more nodes based on at least depth parameters associated with said graph;
selecting, by said one or more processors, a first set of nodes from said one or more nodes based on at least one of said first score and said second score;
determining, by said arithmetic logic unit in said one or more processors, a polarity score for each node in said first set of nodes based on one or more actions performed by users, represented by said first set of nodes, on a second content, wherein said second content is similar to said first content;
determining, by said arithmetic logic unit in said one or more processors, said polarity score for each node in a second set of nodes connected to said each node from said first set of nodes based on a first weight and a second weight, associated with edges connecting said second set of nodes, and said polarity score associated with said each node in said first set of nodes; and
selecting, by said one or more processors, a third set of nodes from said first set of nodes based on at least said polarity score associated with said second set of nodes connected to said each node in said first set of nodes, wherein said third set of nodes represents said one or more target users.

2. The method of claim 1, wherein said first score is a weighted sum of a number of reachable nodes from said first set of nodes, based on said depth parameters associated with said graph.

3. The method of claim 2, wherein said second score is a weighted sum of a number of paths, wherein each path is a sequence of at least one or more edges.

4. The method of claim 3 further comprising determining, by said arithmetic logic unit in said one or more processors, a third score based on said first score and said second score, wherein said third score is further utilized to select said first set of nodes.

5. The method of claim 1, wherein said polarity score is a measure of orientation of said user of said social network towards a content.

6. The method of claim 1, wherein said one or more actions on said second content comprise at least one of sharing said second content, and posting message related to said second content to one or more other users.

7. The method of claim 1, wherein said first weight associated with an edge corresponds to a measure of an influence of a node on other node, wherein said node and said other node are connected by said edge.

8. The method of claim 7, wherein said second weight associated with said edge corresponds to likelihood that other user, depicted by said other node, is influenced with same polarity, towards first content, as that of said user, depicted by said node.

9. A system for identifying one or more target users, of a first content, from a social network, said system comprising:
a graph processor configured to generate a graph comprising one or more nodes and one or more edges connecting said one or more nodes, wherein each of said one or more nodes is representative of a user of said social network, and wherein an edge, from said one or more edges, is representative of an acquaintance between a pair of nodes connected by said edge;
one or more processors configured to:
determine a first score and a second score for each of said one or more nodes based on at least depth parameters associated with said graph;
select a first set of nodes from said one or more nodes based on at least one of said first score and said second score;
determine a polarity score for each node in said first set of nodes based on one or more actions performed by users, represented by said first set of nodes, on a second content, wherein said second content is similar to said first content;
determine said polarity score for each node in a second set of nodes connected to said each node from said first set of nodes based on a first weight and a second weight, associated with edges connecting said second set of nodes, and said polarity score associated with said each node in said first set of nodes; and
select a third set of nodes from said first set of nodes based on at least said polarity score associated with said second set of nodes connected to said each node in said first set of nodes, wherein said third set of nodes represents said one or more target users.

10. The system of claim 9, wherein said first score is a weighted sum of a number of reachable nodes from said first set of nodes, based on said depth parameters associated with said graph.

11. The system of claim 10, wherein said second score is a weighted sum of a number of paths, wherein each path is a sequence of at least one or more edges.

12. The system of claim 11, wherein said one or more processors are further configured to determine a third score based on said first score and said second score, wherein said third score is further utilized to select said first set of nodes.

13. The system of claim 9, wherein said polarity score is a measure of orientation of said user of said social network towards a content.

14. The system of claim 9, wherein said one or more actions on said second content comprise at least one of sharing said second content, and posting message related to said second content to one or more other users.

15. The system of claim 9, wherein said first weight associated with an edge corresponds to a measure of an influence of a node on other node, wherein said node and said other node are connected by said edge.

16. The system of claim 15, wherein said second weight associated with said edge corresponds to likelihood that other user, depicted by said other node, is influenced by said user with same polarity, towards first content, as that of said user, depicted by said node.

17. A computer program product for use with a computer, the computer program product comprising a non-transitory computer readable medium, wherein the non-transitory computer readable medium stores a computer program code for identifying one or more target users, of a first content, from a social network, wherein the computer program code is executable by one or more processors to:
generate a graph comprising one or more nodes and one or more edges connecting said one or more nodes, wherein each of said one or more nodes is representative of a user of said social network, and wherein an edge, from said one or more edges, is representative of an acquaintance between a pair of nodes connected by said edge;
determine a first score and a second score for each of said one or more nodes based on at least depth parameters associated with said graph;
select a first set of nodes from said one or more nodes based on at least one of said first score and said second score;
determine a polarity score for each node in said first set of nodes based on one or more actions performed by users, represented by said first set of nodes, on a second content, wherein said second content is similar to said first content;
determine said polarity score for each node in a second set of nodes connected to said each node from said first set of nodes based on a first weight and a second weight, associated with edges connecting said second set of nodes, and said polarity score associated with said each node in said first set of nodes; and
select a third set of nodes from said first set of nodes based on at least said polarity score associated with said second set of nodes connected to said each node in said first set of nodes, wherein said third set of nodes represents said one or more target users.
